(19) United States
(12) Patent Application Publication
(10) Pub. No.: US 2020/0133651 A1
(43) Pub. Date: Apr. 30, 2020

(54) RELEASE AUTOMATION SERVICE IN SOFTWARE DEVELOPMENT TOOLS

(71) Applicant: CA Software Österreich GmbH, Wien (AT)

(72) Inventors: Markus Holzer, Modling (AT); Peter Miklos Szulman, Baden (AT); Stefan Pomajbik, Vienna (AT)

(73) Assignee: CA Software Österreich GmbH, Wien (AT)

(21) Appl. No.: 16/169,758

(22) Filed: Oct. 24, 2018

(51) Int. Cl. G06F 8/65; G06F 8/33; G06F 8/41; G06F 8/70; H04L 29/08

(52) U.S. Cl. CPC G06F 8/65; G06F 8/33; H04L 67/34; G06F 8/70; G06F 8/427

(57) ABSTRACT

Data is received at a release automation system indicating a project opened in an integrated development environment (IDE) on another system. A deployment model of the release automation system is identified as associated with the project, the deployment model including at least a definition of a workflow to be executed to perform automated deployment of applications and a definition of an environment including one or more target computing systems. Data is received at the release automation system indicating a user interaction with the IDE and a particular definition within the deployment model is determined as being relevant to the user interaction and the project. An interface between the IDE and the release automation system is used to cause information from the particular definition to be presented in a graphical user interface of the IDE based on the user interaction.

### BACKGROUND

The present disclosure relates in general to the field of computing systems, and more specifically, to release automation in computing systems.

Modern software systems often include multiple programs or applications working together to accomplish a task or deliver a result. An enterprise can maintain several such systems. Further, development times for new software releases are shrinking allowing releases to be deployed to update or supplement a system on an ever-increasing basis. Some enterprises release, patch, or otherwise modify their software code dozens of times per week. Further, enterprises can maintain multiple servers to host their software applications, such as multiple web servers deployed to host a particular web application. As updates to software and new software are released, deployment of the software can involve coordinating the deployment across multiple machines in potentially multiple geographical locations.

### BRIEF SUMMARY

According to one aspect of the present disclosure, data may be received at a release automation system indicating a project opened in an integrated development environment (IDE) on another system. A deployment model of the release automation system may be identified as associated with the project, the deployment model including at least a definition of a workflow to be executed to perform automated deployment of applications and a definition of an environment including one or more target computing systems. Data may also be received at the release automation system indicating a user interaction with the IDE and a particular definition within the deployment model may be determined as being relevant to the user interaction and the project. An interface between the IDE and the release automation system may be used to cause information from the particular definition to be presented in a graphical user interface of the IDE based on the user interaction.

### BRIEF DESCRIPTION OF THE DRAWINGS

FIG. 1 is a simplified schematic diagram of an example computing system including an example deployment automation system in accordance with at least one embodiment;

FIG. 2 is a simplified block diagram of an example computing system including an example deployment automation engine in accordance with at least one embodiment;

FIG. 3 is a simplified block diagram illustrating an example system including multiple deployment nodes in accordance with at least one embodiment;

FIG. 4 is a simplified block diagram illustrating an example release automation system in an example automation system in accordance with at least one embodiment;

FIG. 5 is a simplified block diagram illustrating example deployment modeling within an example release automation system in accordance with at least one embodiment;

FIG. 6 is a simplified block diagram illustrating an example implementation of a release automation system providing an interface to example development tools in accordance with at least one embodiment;

FIG. 7 is a simplified block diagram illustrating an example implementation of a release automation system providing an interface to example integrated development environment tool in accordance with at least one embodiment;

FIGS. 8A-8C are screenshots of example development tool graphical user interfaces enhanced by a release automation service provided in accordance with at least one embodiment;

FIG. 9 is a flowchart illustrating use of an example protocol to facilitate communication between a release automation system and development tool in accordance with at least one embodiment;

FIG. 10 is a simplified flow diagram illustrating an example technique for providing a release automation system as a service to enhance an example software development tool in accordance with at least one embodiment.

Like reference numbers and designations in the various drawings indicate like elements.

### DETAILED DESCRIPTION

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely in hardware, entirely software (including firmware, resident software, micro-code, etc.) or combining software and hardware implementations that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, CII, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

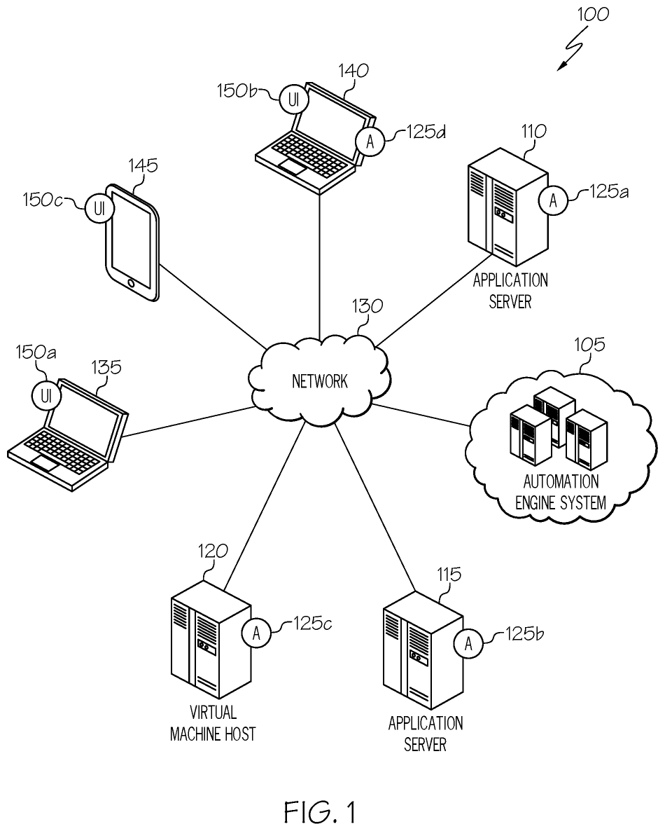

Referring now to FIG. 1, a simplified block diagram is shown illustrating an example computing environment 100 including an example automation engine system 105. The automation engine system 105 may be implemented on one or multiple host server devices and may flexibly implement a variety of software automation solutions and applications including release automation, workload automation, and automated service orchestration. An automation engine system may implement an automation engine implemented through a collection of interconnected work processes (hosted on one or more of the servers of the automation engine system 105) and communication processes (hosted on one or more the servers of the automation engine system 105). The work processes may be configurable to perform tasks to automate a variety of tasks on a computing system local to or remote from the automation engine system 105. For instance, an automation engine hosted on automation engine system 105 may automate workflows utilizing software applications, scripts, applets, or other software programs hosted on one or multiple different target computing systems, such as application server systems (e.g., 110, 115). In other instances, the automation engine may be utilized to orchestrate a service or automate the deployment and installation of a new software release on one or more of these systems (e.g., 110, 115) or other computing systems (e.g., a virtual machine or container-based host system (e.g., 120)), among other examples. Hosts and server systems may also be implemented on personal computing devices (e.g., 140), Internet of Things (IoT) devices, smart home systems, media consoles, smart appliances, and other computing systems, which may interface with an automation engine (on automation engine system 105) over one or more networks (e.g., 130) in connection with workflow automation, release automation, service orchestration, or other software automation applications supported by the automation engine.

In some implementations, agents (e.g., 125a-d) may be provisioned on host systems (e.g., 110, 115, 120, 140) to provide a hook for the automation engine to control operating system tasks or other operations and functionality provided on a host system through an operating system, hypervisor, application, or other software program, which may facilitate a workflow automation, release automation, service orchestration, or other software automation implementation. An automation engine may communicate with various agents deployed within host systems (e.g., 110, 115, 120, 140), for instance, through communication processes implementing the automation engine. In some implementations, communication processes may support and implement network communications (e.g., over one or more networks (e.g., 130)) between the computing system(s) (e.g., 105) hosting the work processes and other components of the automation engine. Further, in some implementations, user interfaces (e.g., 150a-c) may be defined in connection with the automation engine, which may be accessed on one or more user computing devices (e.g., 135, 140, 145), for instance, as a web-based or browser-implemented user interface. Users may provide inputs and define parameters for an automation implemented by the automation engine through these UIs (e.g., 150a-c). The inputs may be routed to one or more of the work processes of the automation engine using the communication processes of the automation engine, to allow for the definition of user-customized automations and even the definition of new or customized automations provided through the automation engine, among other examples.

In general, “servers,” “clients,” “computing devices,” “network elements,” “database systems,” “user devices,” and “systems,” etc. (e.g., 105, 110, 115, 120, 135, 140, 145, etc.) in example computing environment 100, can include electronic computing devices operable to receive, transmit, process, store, or manage data and information associated with the computing environment 100. As used in this document, the term “computer,” “processor,” “processor device,” or “processing device” is intended to encompass any suitable processing apparatus. For example, elements shown as single devices within the computing environment 100 may be implemented using a plurality of computing devices and processors, such as server pools including multiple server computers. Further, any, all, or some of the computing devices may be adapted to execute any operating system, including Linux, UNIX, Microsoft Windows, Apple OS, Apple iOS, Google Android, Windows Server, zOS, etc., as well as virtual machines and emulators adapted to virtualize execution of a particular operating system, as well as container-based operating environments (e.g., Docker containers, Kubernetes containers, etc.), and customized and proprietary operating systems among other examples.

Further, servers, clients, network elements, systems, and computing devices (e.g., 105, 110, 115, 120, 135, 140, 145, etc.) can each include one or more processors, computer-readable memory, and one or more interfaces, among other features and hardware. Servers can include any suitable software component or module, or computing device(s) capable of hosting and/or serving software applications and services, including distributed, enterprise, or cloud-based software applications, data, and services. For instance, in some implementations, an automation engine system 105, application server (e.g., 110, 115), host server 120, or other sub-system of computing environment 100 can be at least partially (or wholly) cloud-implemented, web-based, or distributed to remotely host, serve, or otherwise manage data, software services and applications interfacing, coordinating with, dependent on, or used by other services and devices in environment 100. In some instances, a server, system, subsystem, or computing device can be implemented as some combination of devices that can be hosted on a common computing system, server, server pool, or cloud computing environment and share computing resources, including shared memory, processors, and interfaces.

While FIG. 1 is described as containing or being associated with a plurality of elements, not all elements illustrated within computing environment 100 of FIG. 1 may be utilized in each alternative implementation of the present disclosure. Additionally, one or more of the elements described in connection with the examples of FIG. 1 may be located external to computing environment 100, while in other instances, certain elements may be included within or as a portion of one or more of the other described elements, as well as other elements not described in the illustrated implementation. Further, certain elements illustrated in FIG. 1 may be combined with other components, as well as used for alternative or additional purposes in addition to those purposes described herein.

Through the advent of cloud and distributed computing architectures, together with agile software development paradigms, the management and implementation of software systems by enterprises has become increasingly complex. For instance, as computing systems migrate to cloud or hybrid cloud environments, managing workflows and deployment of new software may be more complex and costly without information technology automation. Further, given the rapid pace of software innovation, versioning, and updates, the pace at which software is released and orchestrated has likewise increased. For instance, in the case of release automation, releases and updates may be frequent, complex, and expensive to deploy in modern software systems. Managing the potentially thousands of software releases, even relating to a single entity's (e.g., enterprise's) system, can be difficult and exact costs on the very operability of the system. Such releases include both releases of new software systems as well as updates or patches to existing software. Valuable information technology (IT) personnel and resources are dedicated within some enterprises to developing and carrying-out these deployments. Traditionally, human users are employed throughout the process of the deployment. Further, human IT resources are not only expensive, but error prone, resulting in some deployments which are incorrect and that may need to be re-deployed, further consuming time and personnel resources. Additionally, some systems may be sensitive to down periods that may be required in order to allow deployment of new software releases on the system, among other complexities, costs, and variables. Similar complexities and costs are introduced when considering the orchestration of new services, managing workflows in transactions to be handled and developed using a software system, among other example considerations.

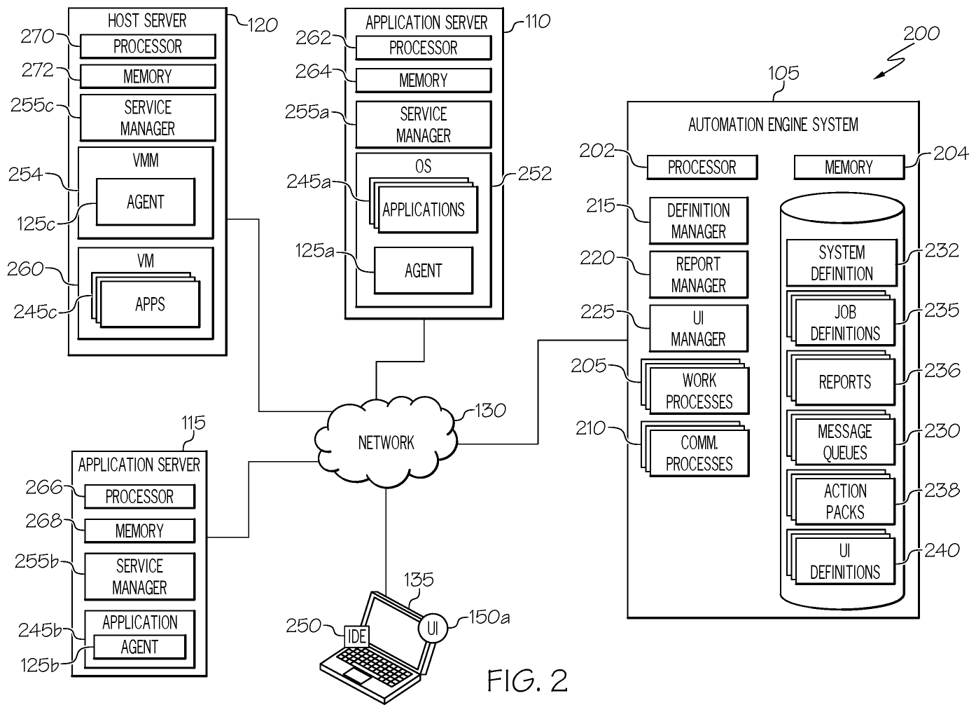

Automation tools and processes may be purpose built to handle common automation tasks, however, given the diversity and continuing evolution of enterprises' software systems, specialized, purpose-built automation tools are often ill-equipped to adapt to the ever-changing landscape of modern software products and systems. In some implementations, a flexible, scalable, and configurable automation engine may be provided, which is capable of being used, reused, and repurposed, dynamically, to provide a single automation platform capable of handling and be extended to handle a wide and diverse array of automation workloads and tasks. At least some of the systems described in the present disclosure, such as the systems of FIGS. 1 and 2, can include functionality providing at least some of the above-described features that, in some cases, at least partially address at least some of the above-discussed issues, as well as others not explicitly described.

For instance, in the example of FIG. 2, a simplified block diagram 200 is shown illustrating an example environment including an example implementation of an automation engine system 105. An automation engine implemented using the automation engine system 105 may be composed of a collection of work processes 205 and communication processes 210. Work processes (e.g., 205) are server processes implemented within the automation engine to perform the actual server work in various automations, such as activating, generating, and executing tasks within a given automation job, together with monitoring the status of the tasks and collecting information (and generating report data) relating to the completion of these tasks. Work processes 205 may retrieve tasks from a queue, with the tasks including logic executable by the work process to cause the work process to perform a particular type of task. When the work process 205 accesses a next task from the queue, it may retrieve corresponding logic and perform the next task, which may be the same or a different type of task than the work process's previously performed task. Indeed, the flexibility of the work processes allow a configurable mix of tasks and corresponding jobs to be handled by the collection of the work processes 205 in the automation engine, allowing the automation engine to respond dynamically to what may be a changing and diverse workload the automation engine is called on to handle. In other instances, work processes may be configured to be dedicated to handling particular types of high priority or low latency tasks, such that all of the work process's bandwidth is directed toward these types of tasks in the automation engine's workload (e.g., despite the work process being otherwise operable to handle potentially any one of the variety of tasks in jobs handled by the automation engine).

Further, one of the work processes implemented in the automation engine may be designated as the “primary” work process. A primary work process, in some examples, may be designated at the launch of the automation engine (e.g., based on the work process being the first to start) and this primary work process may be assigned special tasks based on its designation as the primary process, such as central work process tasks. In some cases, the primary work process may be tasked with autonomously assigning roles to additional work processes as they are started within the automation engine. In some implementations, work processes may be assigned roles to filter the types of tasks the respective work process is to handle. For instance, some work processes may be assigned (e.g., by the primary work process) to perform an output server role to handle outputs such as storing log messages and reports generated in the automation engine within a database of the automation engine. Another example server role which may be assigned to work processes may be a resource calculation role to perform tasks such as calculating calendar objects, perform deadlock avoidance, and other tasks, which involve calculations, among other examples. In some implementations, separate queues may be maintained in the automation engine database for each server role, such that tasks of a given work process are extracted from the specific queue corresponding to the work process's assigned role, among other example features and implementations.

Communication processes (e.g., 210) are additional server processes running on one or more computing systems (e.g., 105) implementing an instance of an automation engine. Communication processes 210 may handle communication between agents (e.g., 125a-c)), user interfaces (e.g., 150a), and work processes (e.g., 205) in connection with the automation engine. Communication processes hold the connections to the agents and the user interfaces. In some implementations, all communication between agents and UIs may be exclusively performed through the communication processes 210. In some implementations, port numbers of the systems hosting the automation engine may be assigned to respective work processes and communication processes. All of the server processes (e.g., work processes 205 and communication processes 210) may communicate with each other. Such an architecture can ensure flexibility and fault tolerance, allowing remaining processes to assume the queued tasks of another process in the event the other process fails, among other example features and advantages.

As noted above, a communication process can connect with agents (e.g., 125a-c) and UIs (e.g., 150a) to facilitate the communication between the agents and UIs and various work processes (e.g., 205) of an automation engine implementation. Agents may be implemented on target systems (e.g., 110, 115, 120) to expose functionality of an operating system (e.g., 250), application (e.g., 245b), virtual machine manager (e.g., 254), or other software program to the automation engine. Accordingly, agents may be implemented according to the specific features of the target software component (e.g., 245b, 250, 254, etc.). As an example, different agents may be provided for instrumentation on any one of a variety of different operating systems, such as agents specific to Windows, Linux, iOS, zOS, etc., among other examples. In some implementations, agents may initiate connections with one of the communication processes provided in an automation engine. For instance, an agent may open a TCP/IP connection with one of the communication processes of the automation engine. In some implementations, each agent may connect to a single one of the communication processes, while each communication process may be connected to multiple agents and/or user interfaces. Communications between the agent and a communication process may be encrypted.

As discussed in the examples above, a collection of work and communication processes may be provided in an automation engine system. In some cases, it may be advantageous to host the work processes 205 and communication processes 210 on multiple nodes or computing devices, as this can enhance fault tolerance of the automation engine and boost efficiency and reliability through the distribution of these processes over several computers. In some implementations, a potentially unlimited number and variety of work and communication processes may be implemented in a single automation engine instance. Further, by adding processes it is possible to adjust to growing use of the automation engine system. For instance, should a heavy workload exist or be introduced due to the number of logged-on agents and/or UIs, the number of communication processes can be increased. Likewise, should the number of automation engine system tasks become too burdensome, the number of work processes can be increased, among other example advantages.

As further illustrated in FIG. 2, an example automation engine system 105 may include one or more data processing apparatus (e.g., 202), one or more computer memory elements 204, and other components and logic, implemented in hardware circuitry and/or software to implement an automation engine instance. For instance, a definition manager 215 may be provided, through which a system definition file 232 may be accessed, modified, and/or defined. A system definition 232 may define the number of work processes 205 and communication processes 210 within an automation engine instance, as well as detail the individual computing systems hosting these server processes, the ports assigned to each process, among other information utilized to define an automation engine instance. A definition manager 215 may additionally access and/or define job definitions, which may correspond to automation jobs that may be performed by the automation engine. The job definitions 235 may additionally detail the combination of automation tasks and the target systems involved in the performance of these tasks in the furtherance of such automation jobs. Automation jobs may provide the information to be loaded into work queues consumed by work processes 205 in the automation engine. In some cases, automation jobs may be packaged in action packs (e.g., 238), which may be pre-generated packages of common types of automations, which may be reused and redeployed in various customers' respective automation engine instances. An individual instance of an automation engine may allow a user or manager to parameterize the action pack to enable the action pack's use within a particular customer's system (with its component target systems) (e.g., using definition manager 215). In some implementations, a report manager 220 may also be provided, which may enable user access to reports 236 and other data generated through the execution of various automation jobs by the automation engine (e.g., as generated by work processes 205 within the automation engine). A UI manager 225 may also be provided, in some implementations, to allow users or managers to define new UIs or parameterize UI templates for use in providing UIs (e.g., 150a) that are to interface with and be used in connection with automation jobs performed by an automation engine deployment. UI definitions 240 may be generated and maintained by the automation engine system 105 to form the basis of these UIs (e.g., which may be presented through web- or browser-based interfaces on potentially any user endpoint device (e.g., 135) capable of connecting to the automation engine over a private or public network (e.g., 130)). User devices may also be used to assist in the development of software applications and application components, which may be deployed into a target environment using the automation engine. For instance, one or more development tools (e.g., 250), such as an integrated development environment (IDE) may be hosted on a user device (e.g., 135). In some instances, functionality provided through the automation engine may be exposed to and accessible through an enhanced development tool (e.g., 250) to assist in imparting intelligence and functionality from the automation engine and related systems to such development tools, such as discussed later below.

In some implementations, communication between server processes of an automation engine (e.g., its component work processes 205 and communication processes 210)) may be facilitated through message queues 230. Message queues (as well as other data used to implement an automation engine instance (e.g., 232, 235, 236, 240, etc.)) may be hosted in a database implemented in connection with the automation engine and hosted on one of the computing systems of automation engine system 105. Message queues (e.g., 230) may be implemented as database tables, through which a work or communication process may post a message that may then be read and processed by another work or communication process, thereby facilitating communication between the processes. Additional queues may also be provided which contain the tasks that are to be accessed by server processes and performed in connection with an automation engine implementation. In some implementations, an automation engine instance may have multiple message queues. Depending on their types, tasks are lined up in the corresponding queue. If a work process is momentarily idle or finished with its current tasks, it will take the next queued task and process it. The execution of the task can lead to a new task for the work queue to be then attached to the current tasks. Some tasks may be dedicated tasks, which are allowed to only be processed by the primary work process. Accordingly, in such implementations, a primary work process, upon completing a preceding task, may first check (in a corresponding queue) whether any special work tasks are waiting in the queue before turning to more general work queues for generally work tasks shared with the other work processes. or this reason, the “freed-up” primary work process always checks first if any of these special work processes are present in the queue. Communication processes may utilize communication queues for communication tasks to be performed by communication processes to collect or send data from/to agents and/or UIs associated with the automation engine. In some instances, if a work process tasks involves the passing of information to agents or UIs, the work process may, as part of the performance of its task, write a new communication queue to the respective communication queue in order to prompt the communication process's involvement in the passing of this information, among other examples.

As noted above, an automation engine provided through an automation engine system 105 may be used to automate activities on various target systems (e.g., 110, 115, 120). For instance, application servers (e.g., 110, 115) hosting various applications and other software tools and programs (e.g., 245a-b) may be target systems of an automation engine. For instance, tasks automated by an automation engine may automate deployment of a new or updated version of an application or system of interoperating programs on one or more computing systems (e.g., 110, 115, 120). In other examples, a workflow involving one or more multiple different cooperating applications (e.g., 245a-c) may be automated may be automated using an automation engine, among other examples. The automation engine may interface with agents to cause functionality present on the target system to be triggered and automated according to defined automation engine tasks and jobs. In some instances, agents (e.g., 125a) may be present on an operating system (e.g., 250) of the host system (e.g., 110), on which a target application (e.g., 245a) runs. In other instances, the agent (e.g., 125b) may be present on the application (e.g., 245b) itself. During the automation of a workflow, the automation engine may communicate with and cause actions to be performed on multiple different applications (e.g., 245a-c) and host systems (e.g., 110, 115, 120) through corresponding agents (e.g., 125a-c). In automation jobs involving service orchestration or release automation, agents (e.g., 125a, c) may be used to access functionality and resources of the system that are used to deploy, install, configure, load, or otherwise automate deployment or installation of a program on one or more target systems. As an example, an application may be automatically deployed on a virtual machine using an example automation engine, through the automation engine's communication with an agent (e.g., 125c) provided on a virtual machine manager (VMM) or hypervisor (e.g., 254) that is to automatically build the host virtual machine (e.g., 260) upon which the application (e.g., 245c) is to be installed and run at the direction of the automation engine, among other examples.

In some implementations, a service manager process (e.g., 255a-c) may be present on any host system (e.g., 110, 115, 120, etc.) that is to host one or more agents (e.g., 125a-c) that are to interface and interoperate with (and at the direction) of an automation engine instance. In some implementations, a service manager (e.g., 255a-c) may manage and govern the activation and deactivation of agents (e.g., 125a-c) on the host (e.g., 110, 115, 120). Further, in cases where one or more processes (e.g., communication processes, work processes, etc.) implementing the automation engine are hosted in a distributed manner on various machines (e.g., 120), a service manager (e.g., 255c) may likewise manage and serve as the parent process of these processes (e.g., work processes 205b). As shown in the example of FIG. 2, a host system (e.g., 120) may not only host one or more agents (e.g., 125c), but may also host one or more automation engine processes (e.g., 205b), with the service manager (e.g., 255c) on the host (e.g., 120) serving as the parent process and centralized manager for all of these processes. The service manager (e.g., 255a-c) may be automatically launched in connection with the activation or reboot of a given host system (e.g., 110, 115, 120), such as on or shortly after the host system reboots. Other automation engine components (e.g., 125a-c, 205b, etc.), however, may depend on the service manager (e.g., 255a-c) for activation. The service manager may control how, when, and in what order various automation engine components are launched. The service manager may also orchestrate and manage the upgrade and installation of new agents and automation engine processes on its host, among other example functionality. The service manager may launch with elevated privileges, enabling the service manager to start sub-processed in accordance with these privileges (e.g., even if the human user does not otherwise possess such access rights), among other example features.

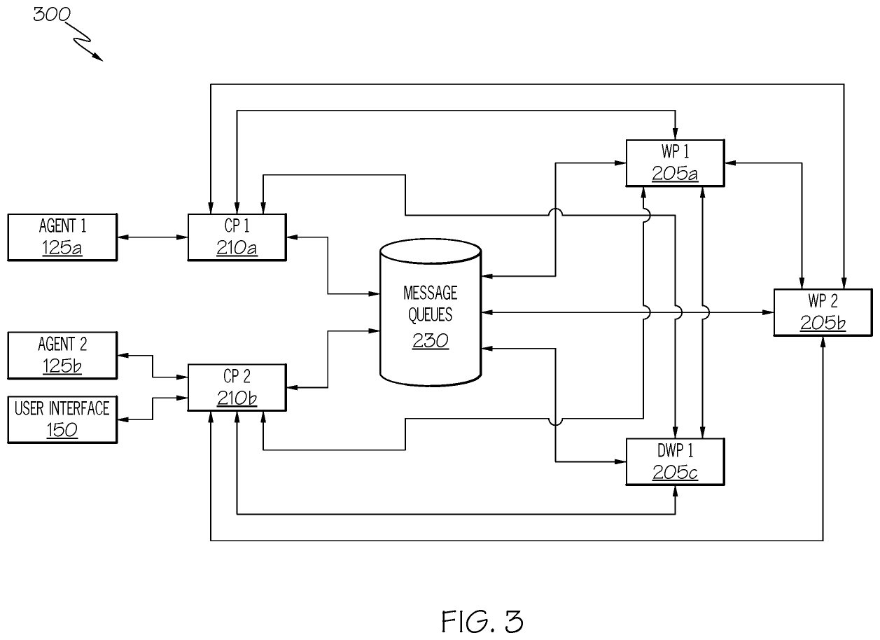

Turning to FIG. 3, a simplified block diagram 300 is shown illustrating an example automation engine implementation. In this simplified example, the automation engine may be implemented through work processes 205a-c, communication processes 210a-b, and a database hosting automation engine information including tables implementing message queues (e.g., 230) of the automation engine. In this example, work process 205a may be designated as the primary work process and may connect with and oversee the launch of the other work processes (e.g., 205b-c) in the automation engine. One or more of the work processes (e.g., 205c) may be a dedicated work process, dedicated to performing a particular type of task (e.g., a dialogue work process (DWP) specifically for use in handling UI messages (e.g., from UI 150)), while other work processes (e.g., 205b) are general purpose work processes, which may be utilized to handle potentially any type of work task to be performed in the automation engine. Each work process (e.g., 205a-c) may interface with one or more message queue tables to obtain new tasks for execution and/or communicate messages with other work processes or communication processes in the automation engine. Likewise, communication processes (e.g., 210a-b) may interface with message queues 230. Some message queues may be dedicated message queues, reserved for a particular subset of the server processes (e.g., 205a-c, 210a-b) in the automation engine, while other queues may be provided for access and use by potentially any one of the automation engine server processes. Each communication process (e.g., 210a-b) may be connected to one or more agents (e.g., 125a-b) and/or one or more UIs (e.g., 150) provided for interfacing with the automation engine. Agents (e.g., 125a-b) may expose functionality of a target system for use by the automation engine. UIs may be provided to enable users to submit information for use by the automation engine and/or to present information (e.g., prompts, results, status updates, etc.) generated by the automation engine to the user, among other examples.

It should be appreciated that an automation engine may include any potential number of one or more work processes and communication processes. As the workload to be handled by the automation engine or the general complexity of the automation engine implementation increases, additional work and/or communication processes and corresponding message queue tables may be added to expand the bandwidth and flexibility of the automation engine. Likewise, the scale and scope of an automation engine may also be reduced, by removing work and/or communication processes, among other examples. As an illustrative example of a job, which may be performed by an example automation engine, a workflow involving an example customer relationship management (CRM) platform may be automated using an example automation engine, such as shown in the example of FIG. 3. Jobs may be defined, which are designed to automate the generation of social media promotions (e.g., handled by a first target system) based on events detected using a second target system (e.g., a system that can forecast or detect weather patterns and/or predict foot traffic within a retail establishment, etc.).

In one example, when certain weather conditions are detected or predicted, an example workflow can cause a social media management system to automatically generate a promotional posting on one or more social media platforms to promote an offering appropriate for the detected weather (e.g., an ice cream promotion on a hot day). For instance, a first one of the work processes (e.g., 205b) may perform a task to cause a weather forecast to be performed using a first target system. The performance of this task may involve causing a communication process (e.g., 210a) interfacing with the target system through a corresponding agent (e.g., 125a) to send a communication to the agent to engage with the target system and cause the target system to generate forecast data. This forecast data may be passed back to the automation engine by the agent 125 through the communication process 210a, and the forecast data may be provided to a message queue and cause a task to be performed by one of the work processes to access and process the forecast data returned from the target system. For instance, work process 205a may be free to handle the task of processing the forecast data, with the task involving determining a weather event from the forecast data. In one example, a work process 205a may determine that the forecast data evidences a warm weather event. The detection of a warm weather event may cause a task to be queued to trigger the social media promotion on a social media system. The workflow definition may embody the logic, executed by the work processes to determine an action, result, or next task to execute based on results of the preceding task. In one example, a free work process may access the queued task and communicate an instruction to launch the social media promotion through a communication process (e.g., 210b) interfacing with the social media system through a corresponding agent (e.g., 125b), among other example implementations and use cases. Indeed, it should be appreciated that potentially any combination of the provided work processes (e.g., 205a-c) in the automation engine may perform various tasks within a single automation job (e.g., a workflow automation job, service orchestration job, release automation job, etc.) based on the availability of the various work processes. Further, an automation engine may simultaneously handle multiple different automation jobs using the same collection of work processes and communication processes 210a-b, balancing work of the multiple jobs between the collection of processes in the automation engine, among other example implementations.

In some implementations, when an agent is launched on a particular target or host system for operation with a particular automation engine, the agent may attempt to identify and connect to the automation engine through one of the communication processes provided in the automation engine. For instance, a service manager utility present on a particular host computer may select a particular agent implementation and designate this agent for use with a particular one of potentially many different automation engines. The agent, too, may be selected from one of potentially many different agent implementations offering various functionality and/or compatibility with various different operating system, software containers, applications, and the like. The service manager may then cause the agent to be loaded and run on the particular host machine. In some implementations, without a connection to a communication process of the selected particular automation engine, the agent is unable to interface and operate with the particular automation engine. A load balancing algorithm may be employed to govern how agents connect to which communication processes within the corresponding automation engine, among other example features.

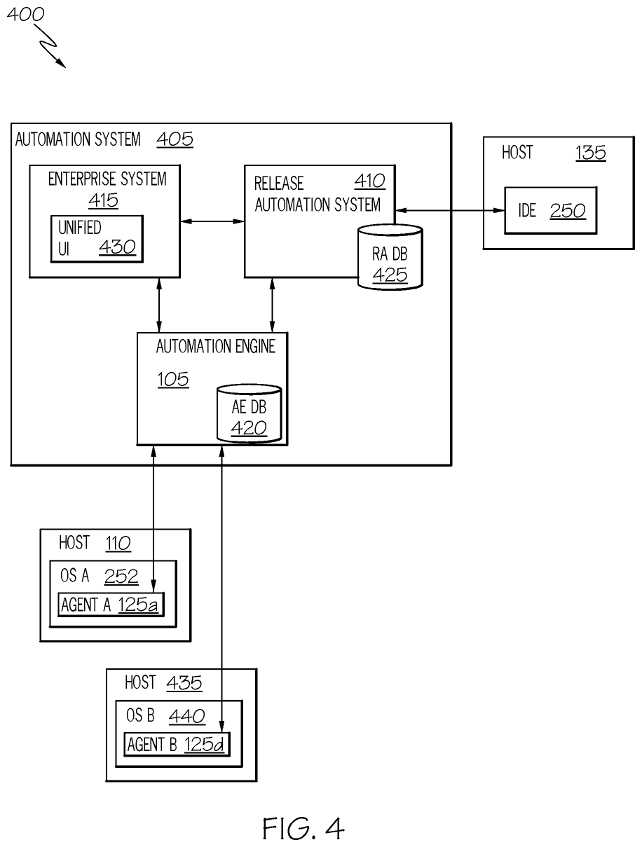

In some implementations, the functionality and infrastructure provided by an automation engine instance, such as discussed above, may serve as the foundation for a release automation system. Turning to FIG. 4, a simplified block diagram 400 is shown illustrating an example automation system, which includes a release automation system 410. An application release automation system may provide users with an end-to-end solution for planning, coordinating and automating software release processes, including automated deployments of complex multi-tier applications and configurations across heterogeneous large-scale server environments, among other simpler deployments. The release automation system may serve to unify enterprise application and infrastructure automation functionality onto a single platform (e.g., as opposed to a cobbled together solution composed of multiple tools). Users first architect and control the execution of application process flows, then orchestrate the underlying infrastructure to meet required service levels. The release automation system may maintain and construct models and other data to improve visibility across the enterprise deployment chain, and provide a continuous delivery solution to address critical DevOps challenges. IT operations, development teams, and application owners can use the release automation system to help speed up application release cycles, improve business and operational agility, simplify and standardize application release processes to reduce errors and increase quality, reduce application deployment costs, and promote collaboration and alignment between development and operations.

An example release automation system may possess functionality to enable an automation flow that includes both application design and application deployment. In application design, the release automation system may provide tools to enable a user or group of users to develop a deployment model including objects defining, representing, or otherwise describing an application (e.g., a multitier application) to be deployed, server types and components that represent the architecture of the application, processes that use actions, flows, and parameters to represent the application deployment logic, artifacts required to deploy the application, and environments to which to deploy the application, among other example information. To deploy such an application, the release automation system provides deployment templates that compile created processes as deployment steps, milestones that represent a sprint or other development milestone, deployment plans that associate the deployment steps with an artifact package, and a deployment that deploys the deployment plan to any number of environments. To deploy designed applications, the release automation system logic uses processes to create deployments. Automation engine logic may be utilized to cause one or more of such processes to be performed using one or more agents provided on a target environment. Each process functions as a deployment step. The deployment model determines the order of the deployment steps and acts as a framework for the deployment plan. The deployment plan associates the deployment steps with an artifact package and holds the release-specific parameter values. From the deployment plan, the release automation system creates deployments for specific environments. Multiple deployments may be created and run from a single deployment plan.

In the simplified block diagram 400 of FIG. 4, an automation system 405 may include an instance of an automation engine 105, a release automation system 410 leveraging the automation engine 105, and an enterprise control module 415. The enterprise control module 415 may provide a unified graphical user interface 430 allowing a user to handle or monitor the components of the automation system 405 centrally. The user interface provided through the enterprise control module 415 may be implemented as a web-based (e.g., browser-based) interface, among other example implementations. The release automation system 410, as introduced above, may provide release and environment management, and further provide functionality for planning and monitoring release automation tasks as well as triggering automated deployments and other procedures relating to continuous release automation provided through the automation system 405. The release automation system 410 may also be used to define application deployments, embodied in deployment models generated and maintained using the release automation system 410 to define the application components, packages, environments, deployment plans or workflows, and all other relevant parameters pertaining to an automated deployment, which may be consumed by the system in performing the actual automated deployment based on a particular one of the deployment models. Deployment models and other data generated, used, and maintained by the release automation system 410 may be stored in a release automation database (e.g., 425) or other data store.

As discussed above, an automation engine 105 may enable the autonomous execution of automation tasks and workflows through work processes in communication with automation engine agents installed on various target systems. The automation engine database (e.g., 420) may contain queues, workflow definitions, actions, related results and statistical data, among other data and data structures used or generated by the automation engine 105. As also noted above, automation engine agents (e.g., 125a, d) may be embodied as software modules installed in and exposing functionality of host target system (e.g., 110, 435) operating systems (e.g., 252, 440). With deployment automation workflows, the agents (e.g., 125a,d) provide a de-centralized service for the purpose of deployment, either executing processes on a target operating system or providing connectivity to a target system (e.g. for databases or middleware). The agents execute automated procedures (as provided in corresponding logic) directly to target systems of the deployment.

In some implementations, various development tools (e.g., integrated development environment (IDE) 250) may be utilized in connection with the development, updating, or editing of code of application components, which may eventually be the subject of an automated deployment using release automation system 410. In some examples, an interface or plugin may be developed to enable a development tool to interface with the release automation system 410 (and potentially other components of automation system 405) to enhance the functionality and information available natively through the development tool. For instance, a development tool 250 on a particular host machine 135 may interface with the release automation system 410 to enable functionality of the release automation system 410 to be exposed and accessed through the graphical user interface (GUI) of the development tool itself. Further, the functionality and information provided through the development tool 250 may be enhanced and modified through the interface with the release automation system 410 to provide deployment- and application-specific contexts and information to be considered and integrated with projects a user may develop or modify using the development tool, among other example uses and features, such as will be laid out in the following paragraphs.

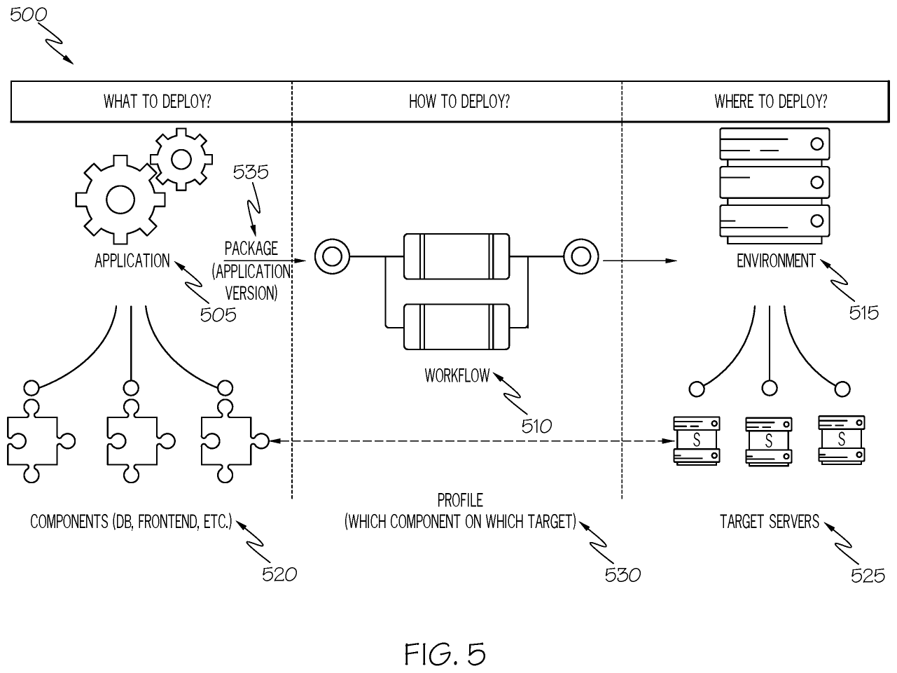

FIG. 5 is a block diagram 500 representing the information included within deployment models of an example release automation system within the context of an example deployment. An application definition 505 may describe the attributes and architecture of an application for which a deployment is to be performed. The application may be composed of multiple different components 520, which may be architected in a multi-tier and/or distributed manner. The application definition 505 for an application may define the components, how they interact, the dependencies of each, as well as other parameters describing the nature and desired configurations to be applied to the various components. Deployments performed by the release automation system may involve the deployment of a subset of one or more of the components of the defined application, such as a new component or update to an existing component, as well as deployments of an entire end-to-end application.

Continuing with the above example, workflow definitions 510 may also be contained within a deployment model and define the particular steps and processes (as well as identify the executable computer logic blocks or scripts) that are to be utilized to perform these processes (e.g., at agents installed on the target systems of the deployment). The workflow definitions 510 may be considered deployment plans and represent reusable and target-system-independent workflows, which may be reused in the deployment of multiple application and component instances of a variety of different target systems. The environment definitions 515 may define attributes of a particular host computing environment. The environment may be composed of multiple target systems 525, and the environment definition may specify attributes for use during the automated deployment (e.g., address and access information).

The application and environment definitions may provide a more global view of the application and environment within a deployment model maintained at the release automation system. Additional definitions may be composed for and used within the deployment model to identify the specific portions of the application and environment involved in a specific automated deployment process. For instance, a profile definition 530 may define, for a deployment process, a link between a specific application component and a specific target server 525, such that a workflow links deployment of this component to the specific target server. A package definition 535 defines the scope of the one or more components 520 that are to be deployed to a specific one of the target systems 525, identifying and describing the specific instance, versions, revisions, or tags of the collection of application artifacts that are to be deployed. Accordingly, the performance of an application deployment workflow using the release automation system involves selecting and running one of the defined workflow definitions within the context defined by a specific package definition 535 and profile definition 530.

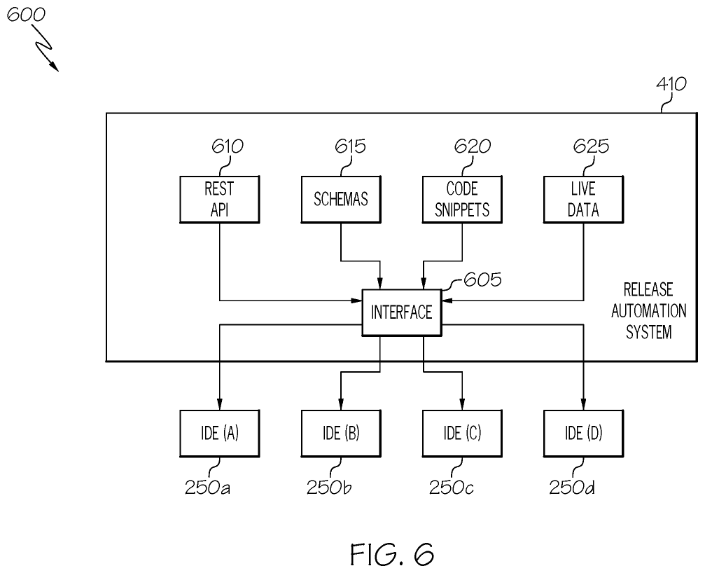

Turning to FIG. 6, a simplified block diagram 600 is shown illustrating a representation of an example release automation system 410 offered as a service to interface with and expose functionality to any one of multiple different development tools, such as different integrated development environments (IDEs) 250a-d. The various IDEs 250a-d may be different IDE products, IDEs developed and provided by different developers, and IDEs capable of supporting development of code in multiple different programming languages. In the example illustrated in FIG. 6, the release automation system 410 may expose its functionality and deployment models to a variety of different development tools as an “as-code service” through an interface 605, which the multiple different development tools 250a-d may each support. The interface 605 may enable any one of these development tools 250a-d to access aspects such as APIs 610 (e.g., a Representational State Transfer (REST) application programming interlace (API) (REST API)), schemas 615 of applications and environments of particular enterprise systems (e.g., as defined in deployment models of the release automation system) and the language scheme used by the release automation system (e.g., a JSON-based schema), code snippets, samples, and templates (e.g., 620) based on applications modeled in the release automation deployment models, and live data 625 describing actual application deployments performed, monitored, and accessible through the release automation system, among other examples. Such information and functionality may then be used directly and seamlessly within the development tool to enhance the ability of a developer to develop effective application components within a continuous deployment or agile development pipeline.

In one example implementation, the interface 605 of an example release automation system 410 may be implemented through a common protocol supported by multiple different development tools, allowing a common interface definition across these different tools. The common protocol may be used by a variety of different services to enable interaction between the services and supporting development tools, allowing the functionality and programming language support of the development tools to be extended, not through individually designed and maintained plugins, or updates to the development tools' native functionality, but by allowing the development tool users to tap into remotely provided sources of such functionality and support provided through these various services. In one example, the interface may be implemented using a protocol designed to enable language services to be provided to source code editors, such as would be present in an IDE or other development tool, such as code completion services, refactoring, definition navigation, syntax or validation highlighting, error and warning alerts, among other examples. While some development tools may offer some of these functions natively, implementing such services for each of a variety of different programming languages (which may evolve over time) on each of a variety of different development tools may place an unrealistic burden on the developer. Further, views to specific systems and applications may only be natively adopted in custom-made development tools.

In one example, the interface 605 of an example release automation system may be implemented using Language Server Protocol (LSP) or other similar transactional protocols. A Language Server Protocol interface allows language services to be decoupled from the actual development tools (e.g., 250a-d), with these language service instead being developed and distributed by third parties. Users of a given IDE that supports LSP may then couple the IDE to any variety of LSP language services to extend and customize the functionality made available to developers through the IDE. LSP or similar protocols may be utilized by the release automation system to identify source code edits made for a particular source code project edited using an IDE and provide language services based on the intelligence, functionality, and information contained in the release automation system's deployment models and release automation logic. For instance, through the protocol, individual IDEs 250a-d (or other development tools with source code editors) may connect to the release automation system (e.g., over a network) as clients and provide data describing user's edits or other interactions with the IDE (e.g., the opening of a particular file, a user request to create a new project or code component, characters typed within the source code editor GUI at a particular position with the code components, etc.). In some instances, this data may embody an effective request from the IDE to the release automation system 410 for a language service based on the release automation system's 410 deployment models. In some instance, the IDE's request may identify the type of information or the type of language service desired, and the release automation system may generate a response providing data, which the IDE may then use to offer the deployment-model based language service (e.g., refactoring, code completion, highlighting, etc.) to the user at the development tool.

In addition to providing language services to IDEs, an interface 605 may also enable GUIs of the IDE to be extended and supplemented with information from the release automation engine. Indeed, through the IDE GUI, a user may invoke functionality of the release automation engine, such as obtaining code snippets or templates offered through the release automation engine and based on deployment models (e.g., application or component definitions within the deployment models) to enable such code snippets, samples, and templates to be loaded within a code editor window of the development tool (e.g., 250a-d) and used to create new components, etc. Further, a user may invoke the automated deployment of code edited and developed using the development tool by the release automation engine (according to a particular, corresponding deployment model) through a user command entered through the GUI of the development tool and communicated to the release automation engine through the interface 605, among other example functionality, use cases, and benefits.

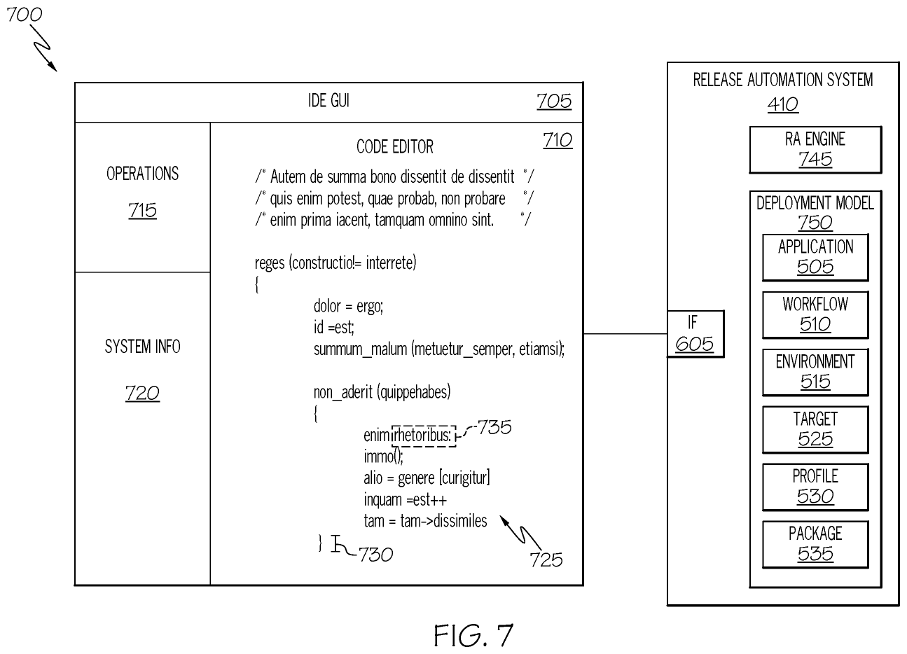

Turning to FIG. 7, a simplified block diagram 700 is shown illustrating an example release automation system in communication with a development tool, such as an IDE tool, through an interface 605. As discussed above, the interface 605 may enable the release automation engine to function as a service to expose functionality (e.g., provided through release automation engine 745) and deployment models (e.g., 750) provided through the release automation system 410 to the development tool. An IDE may include a graphical user interface 705, which enable a user to perform a variety of activities in connection with the development or editing of application components using the IDE. In some implementations, language services and functionality provided through the release automation engine 410 may cause the content and functionality offered through the GUI 705 to be enhanced. For instance, language services, such as code completion, highlighting, validation, etc. may be enhanced based on information contained in the deployment model 750 exposed to the IDE through the interface 605. For instance, the IDE may communicate with the release automation system 410 through the interface 605 to identify that a user has opened a particular component, script, or other project and intends to edit or develop the project further using the code editor window 710 of the GUI 705. Through identification of the project, the release automation engine 410 may identify one or more deployment models (e.g., 750) which are relevant to the project being worked on in the IDE. As a user perform development tasks through the code editor 710, the IDE may communicate these interactions (e.g., the placement of a cursor (e.g., 730) or entry of particular text at a certain point in a block of code (e.g., 725)) and the release automation system 410 may respond to these indications by identifying context and information provided in definitions of the deployment model to offer language services (e.g., a set of valid values for adoption in an object or variable in the code 725, a code completion suggestion, highlighting to indicate a potential error or risk in light of the application definition 505, package definition 535, environment definition 515, etc. corresponding to the application the project relates to, among other hints and services. Accordingly, the release automation system 410 may provide such information as responses to the IDE (through the interface 605) and the IDE may cause corresponding presentations (e.g., 735) within the code editor window 710 to allow a user to adopt or consider this release automation definition information in the code they develop.

In addition to providing language services based on deployment model definitions, the IDE GUI 705 may be further enhanced based on and as a result of its connection with the release automation service 410 (through interface 605) to permit the user to directly access or query information of the release automation system and/or invoke deployment actions defined in workflow definitions 510 and performed using the release automation engine logic 745 (implemented in hardware and/or software) of the release automation system 410. For instance, the GUI 705 may be enhanced with tools, buttons, or other GUI elements to identify one or more functions, provided through release automation engine logic 745, which may be invoked directly through the GUI 705 of the IDE (through interface 605), including functions which may be performed using the code currently edited or developed using the IDE. For instance, upon editing or drafting code for a particular component of an application (in code editor 710), a user may trigger release automation actions to be performed through elements offered in an operations pane 715. For instance, a user may define or refine an application or component definition for the component and/or trigger an automated deployment of the component on a target server using the release automation system 410 using a command input through the enhanced operations pane 715.

In another example, application and/or environment information may be of value to a developed when considering how to develop or edit a given piece of code. A system information panel 720 may be provided or enhanced within a development tool GUI 705 to reflect information contained in deployment models 750 or other data of the release automation system 410. For instance, a user may directly access information describing an application, query live data of a deployment, access schema information, access and copy code snippets based on application definitions 505 directly to the code editor window 710, etc. through a system information pane populated at least partially based on the connection to release automation engine system 410, among other example uses, implementations, GUI layouts, and enhancements.

A deployment model 750 of a release automation system 410 may possess a wealth of information, through its various model definitions, which may be leveraged in queries or language services of a development tool. In one implementation, as shown in FIG. 7, core entities of an example release automation deployment model (e.g., 750) may include an application entity or definition 505, workflow definition 510, environment definition 515, target definition 525, profile definition 530, and package definition 535. In one example implementation, the application definition may serve as the main container of the deployment model 750 and may include definitions of potentially multiple components. As an example, an application may consist of two components, a web application and a database component. Each application component utilizes a specific technology such as Apache Tomcat or a Microsoft SQL database. Such information for each component may be included within the application definition 505. The application definition 505, or entity, may also include component-related workflows to install, upgrade or remove application components, among other example information and data for use in automated deployments. In such examples, the application definition may bundle, for a given application, definitions for each of the application components along with their related workflow definitions (to install, upgrade or remove application components) and dynamic property definitions. Application workflows, which are used to connect individual component workflows into overall deployment sequences, may also be contained within the application definition, as well as more general, application-level dynamic property definitions, which are shared between components.

An application is a piece of software (and possibly related configurations), which are to be released and deployed as a whole. The application definition may include definitions for the composite components of the application. Each component is a single deployable application artifact (e.g., a .war fil to be deployed into a Tomcat container). Each component has different properties which determine where to get it from, how to configure it, and so on. Component artifacts include files and directories stored under version control or in staging areas as well as other objects such as database structure or content stored in a source or staging system. All types of configuration files and objects as well as administrative scripts may belong to component artifacts. Components, and the corresponding application definition, may reflect the tiers of a distributed application to be deployed using the release automation system. The application definition may provide dynamic property definitions on a component-level so that they reflect both the location(s) of all the deployable component artifacts and all the component settings used by the release automation system to configure the component as part of the deployment of the component. For instance, component settings contained within the application definition may include values of all inputs to be provided to corresponding component workflows and settings for customization and configuration of the deployed component (e.g., embodied as configuration files, database tables used by the components, among other examples).

In some implementations, the release automation system may provide a tool, or wizard, to enable users to create an application stack, for instance, by providing an automated guide to usher a user through the steps of creating an application stack from scratch, as well as developing or organizing the composite components of the application. For instance, such an application creation wizard may assist a user with the creation of the application with components, workflows, environments, deployment targets, deployment profiles and packages. Generally, applications are specific to the owner organization to which the application will belong, with its own granularity and scope. The release automation system may assist with the creation of applications from scratch and may additional provide templates, samples, or snippets (from existing applications defined in other application definitions) which may be copied and modified to generate a new application, among other examples.

Workflow definitions are readable by the release automation system and used to carry out physical deployments. A workflow describes all necessary steps for a deployment of a particular corresponding type of application. As an application may consists of multiple different components, the top level of a corresponding workflow (e.g., the application workflow) represents the overall application architecture, while component workflows are used to deploy the individual components. A component workflow may be composed of an assembly or sequence of pre-defined and reusable deployment actions. Accordingly, workflow definitions in a release automation system may be constructed for the tasks in complex processes of release automation. Once defined, workflow definitions may be executed (using automation engine infrastructure) at any time or schedule. The release automation system may monitor the executions to see how the workflows are progressing and may intervene to assist progress of the execution process, such as by detecting errors or bottlenecks, for instance, delaying other deployment tasks or rolling back completed tasks when subsequent tasks fail, among other actions. Workflows may be designed to be operate independently of the target environments and nodes.

As noted above, a workflow definition 510 may include application workflows and component workflows. An application workflow may combine and define orchestration of the execution of the composite component workflows for a complete end-to-end application deployment. Workflows may be used to implement installations, updates, and un-installations of one or more components that are involved in a deployment for a certain application. The application deployment workflow defines the overall process of an application deployment by defining the components are deployed. The component workflows orchestrate the deployment of an individual component (or parts of it) on one or more deployment targets within an environment. Workflow definitions, in some implementations, may additionally include general workflows that are defined to tie together different application workflows and integrate them into larger IT process automation flows. Such general workflows may be used to perform a variety of tasks, such as maintenance tasks like server backups, among other examples.

As noted above, workflows may be defined through a collection of workflow definition tasks and actions. For instance, such steps and actions may include (but are not limited to) preprocessing tasks (e.g., prerequisite checks on disk space or memory, checkouts, exports, file transfers, shutdown service, etc.), execution tasks (e.g., automated copying and/or replacement of files and directories, service creation, customization of configuration files and objects, running database updates, running install scripts, etc.), and post-processing tasks (e.g., start services, validate connectivity, check website availability, etc.). Other workflow tasks may include reading or updating related release artifacts such as defects, feature requests or work items, updating external inventory systems and more. Accordingly, each workflow definition may specify a set of tasks or actions, organized in a combination of sequential and parallel execution paths, combined with conditions, loops, pre- and post-conditions. When executed, the release automation system may cause each action to be executed in parallel or sequentially for one, more or all deployment targets within an environment.

Environment definitions 515 may define an environment consisting of a set of deployment targets which represent individual deployment endpoints. Different environments are used for different phases in the software delivery cycle, for example development, quality assurance (QA), staging, production, etc. The environment definition may include logical associations between individual endpoints and respective software delivery cycle. The environment definition may additional store information concerning access rights and permission control for the environment. For instance, a test environment may be defined which is embodied (and described in the corresponding environment definition) as a virtual machine with four processors, a Unix operating system, and a JBoss 5.1.0, and the environment definition may specify that this environment is to be used primarily for functional tests. It should be appreciated that physical environments described in environment definitions may in fact share hardware and infrastructure components. Settings and properties of the environment (e.g., connection strings) may also be stored in the environment definition, which are common to all deployment targets within an environment (rather than settings specific to individual target systems, which may instead by described in target definitions 525). Indeed, target definitions may describe setting and attributes of individual deployment targets, or target systems, which are embodied as endpoints on which an application component may be deployed by the release automation system. The target definition may identify all corresponding endpoint-related parameters, such as port numbers, IP addresses and directories. Configuration of the corresponding target systems can thus be performed in an automated fashion at the direction of the release automation system using such setting and configuration information (with the tasks being performed at the target systems by corresponding automation engine agents installed on the targets). Indeed, each deployment target may be linked to a respective automation agent (which may likewise be identified in the corresponding target definition). It should be appreciated that a single automation agent may serve multiple different targets and a single target may belong to any number of environments, among other implementation variables.

As introduced above, in some implementations of a release automation system deployment, a deployment profile definition 530 may be provided to define a link between an application and one specific environment. The profile definition 530 may specifically define an intersection between one or more specific application components and one or more specific deployment targets in the environment (e.g., Tomcat application components mapped to a Tomcat deployment target). The deployment profile definition is this used by the release automation system during the deployment execution to define where to deploy to. For each of the dynamic properties stored with a component definition, a profile-specific value may be provided, which may override the default, making it easy to separate the deployment model (what and how) from the environment (where). A deployment profile definition 530 may additionally store all environment-specific property values like connection strings or passwords are set within deployment profiles. In some implementations, each deployment profile for an application can be stored within a separate folder. This allows separation of access rights by environment, e.g. for development, QA, and operations teams.

Further, the deployment model 750 may also include a package definition 535 to define a particular instance (e.g., a version, a revision, a tag, . . . ) of a subject application and define the content which is to deploy (e.g., the entire application or a subset of specified components). Accordingly, in the deployment mode, the package definition 535 defines what will be deployed. A package typically bundles a set of components with its properties, it is assigned to a release to bundle functionality and to allow release managers to plan accordingly. Properties for the component can be set on a package to facilitate deployment of different versions of the same component. In some cases, packages are assigned to releases of an application to bundle new and changed functionality. Different packages may be defined for different deployments. For instance, a deployment package may represent a specific snapshot (set of values) of the dynamic properties of an application deployment model, including the dynamic properties of the application entity itself as well as one, several or all of the components the application is comprised of. A patch package may relate to a release of an application and a (previously installed) deployment package.

In some implementations, each package may follow a defined state flow and you can configure deployment rules for each state transition. State flows may be used to model promotion paths. Indeed, through the concept of packages, a release automation system may support the traceable promotion of a specific application or a specific configuration (variant) of this application into several environments, following a release process from development into production. As an illustrative example, the state flow may include states (and related state transitions) such as READY FOR DEVTEST, DEPLOYED TO DEVTEST, READY FOR STAGING, DEPLOYED TO STAGING, READY FOR PRODUCTION, DEPLOYED TO PRODUCTION and REJECTED. A deployment rule could be created to trigger the release automation system to perform a deployment into the STAGING environment whenever the state READY_FOR STAGING is entered, among other examples. After successful deployment, the state could be automatically updated to DEPLOYED TO STAGING. A release automation system may additional keep an inventory of which packages and specific components within have been deployed to which environments and deployments targets and in which sequence. For example, the value of a dynamic property representing the location of the deployment artifacts of a specific build or release of an application in a version control system could be set on package-level. Therefore, each package can be used to represent a specific tagged software version of this application, although the component artifacts are not “physically” contained in the package but reside somewhere else. Packages may also be used to represent specific configurations of the application. For this purpose, configuration settings (including for example locations of configuration files or other configuration objects) can be modeled as dynamic properties, which receive their target value on package-level, among other example features and implementations.

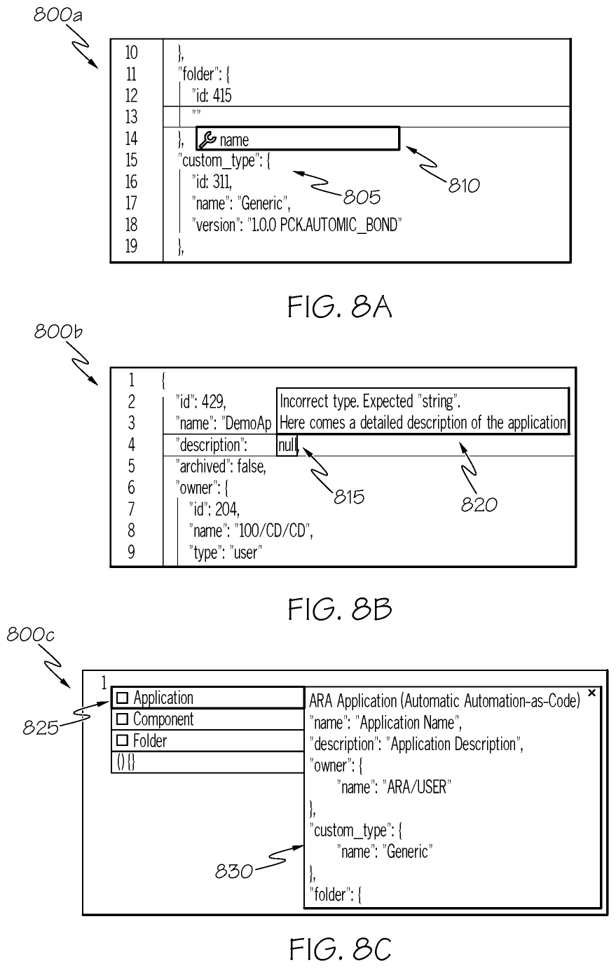

FIGS. 8A-8C are screenshots 800a-c of portions of an example graphical user interface of an example development tool enhanced to interface with a release automation system through an interface (e.g., a LSP-based interface). In one example, a user may launch a development tool and enable the development tool to connect to a release automation system to provide as-code services to the development tool. Once the service is configured it may connect to release automation system. The development tool, in connection with its compatibility with a protocol implementing the interface of the release automation system, may recognize opportunities to contact the release automation system with requests for information in connection with the provision of various language services to the development tool. In this illustrative example, a user may open a project, such a code of a particular application component, within a code editor window of the development tool. In some instance, the user may request a specific application or application component defined in an application definition of a deployment of the release automation system through the release automation system interface. In one example, the use may request a specific application component from the release automation system and, in response, a copy of the code (e.g., implemented as an application component in Javascript Object Notation (JSON)) may be returned through the interface. This JSON file may be stored locally on the machine hosting the development tool and the user may edit the code of the application component using a code editor of the development tool. As shown in the example of FIG. 8A, in some instances, as soon as the user places a cursor at particular positions within the file code and/or starts typing, the development tool may communicate with the release automation system to obtain suggestions to be displayed within the code, based on a deployment model associated with the edited component. For instance, as shown in FIG. 8A, a code completion suggestion 810 (e.g., a recommended or valid folder name, variable value, etc.) may be automatically presented for potential adoption in the code by the user based on the JSON schema and/or information in the associated deployment model based on a user interacting with a corresponding portion of the code 805 presented in the code editor window. In other examples, as shown in FIG. 8B, a validation notification 820 may be presented in response to a user entering particular content within the code 815 based on the development tool interfacing with and obtaining information from the release automation system. The notification (e.g., 820) may be generated on the GUI of the development tool in the form of a highlight, alert icon, or validation message (e.g., 820), among other examples.

As discussed above, in addition to enhanced language services, which may be enabled through an interface with an example release automation system, the interface may additionally enable a user to access various content and functionality of the release automation system directly through user interfaces of the development tool. For instance, in the example of FIG. 8C, a GUI panel or window (e.g., 825) may be presented in addition to a code editor window, through which various resources and functions of the release automation system may be exposed. For instance, in the particular example of FIG. 8C, a user may select a category (e.g., Application, Component, or Folder) from which the user may select and obtain a code template, sample, or snippet based on underlying deployment model definitions of the release automation system. For instance, a code snippet or template 830 may be automatically copied and/or pasted into the code editor window 835 based on the selection, the code snippet being made available through the interface with the release automation system. The user may then edit or modify this snippet to develop a new application or application component, which the release automation system may later employ in an automated deployment. Additionally, the interface with the release automation system may enable other system specific data defined in deployment models to be provided through the as-code service enabled through the interface, such as through a similar information window (E.g., 825) or as a code suggestion within the code editor 835, among other examples. For instance, in connection with a user defining a specific folder within a project, the attempt may be detected and forwarded to the release automation system as a request from the development tool. In response, the release automation system may provide a listing of relevant folders based on a corresponding deployment model, which may be displayed to the user within the GUI of the development tool, among other examples and use cases.

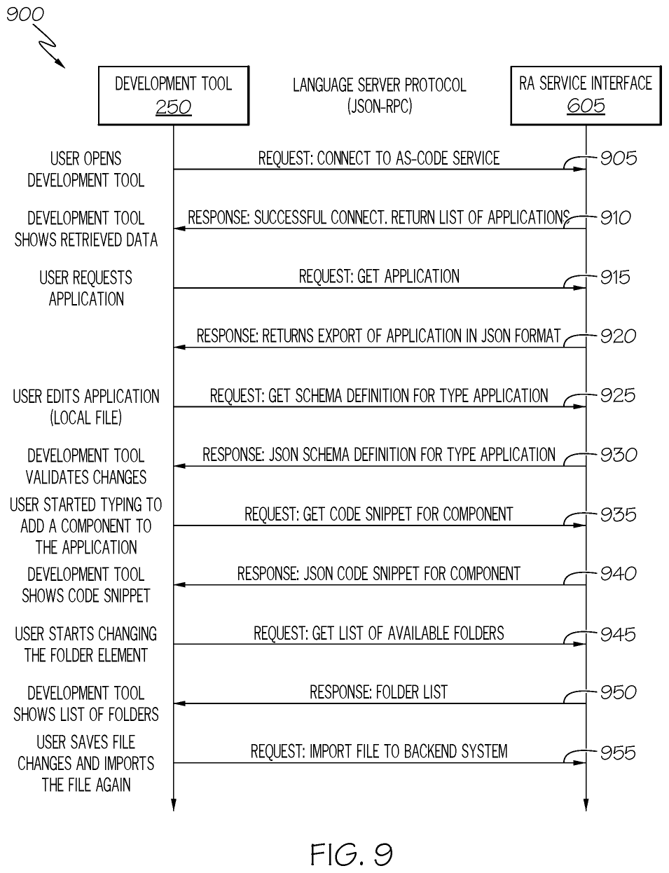

In connection with an interface to one or more development tools, the release automation system, as discussed above, may be offered as an as-code service. To implement this service, the service or interface may be implemented as its own process on the release automation system platform and be considered, in some implementations, as an endpoint similar to a REST API. In some implementations, such a service may be pluggable, meaning it can also be attached to other automation services (e.g., workload automation, etc.) built on top of an automation engine platform. Turning to the simplified block diagram 900 of FIG. 9, an example development tool 250 (e.g., Eclipse, Notepad++, Visual Studio Code, Vim, etc.) may connect to and communicate with the as-code service implementation of a release automation system (e.g., referred to in this figure as the RA service interface 605) using a transactional protocol, such as a Language Server Protocol (LSP).

In the particular example illustrated in FIG. 9, a user may open the development tool 250, causing the development tool 250 to generate an LSP request 905 to connect to the release automation system (RA) service. The RA service interface 605 may respond with a successful connection response 910. The response 910, in some implementations, may also provide a listing of applications (corresponding to related deployment models), which the development tool user may access and utilize in connection with the development tool (e.g., based on an account or permissions of the user (which may be communicated in the request 905 or preceding configuration step). The development tool may present the provided application information to the user through a GUI of the development tool and the same GUI may be used to receive a selection by the user of a particular one of the applications (in connection with a project to be worked upon by the user in the session). Accordingly, another request 920 may be sent to indicate the application and the RA service interface 605 may return, in response, an export of the application (e.g., in JSON format). In this example, the user may load the exported file and begin editing, which may cause the development tool 250 to send a request 925 for a schema definition related to the application. The schema definition may be returned (at 930) by the RA service interface 605, enabling the development tool to have a view into the context of the project being edited by the user.

Continuing with the simplified example of FIG. 9, based on the schema for the application the development tool may monitor interactions of the user with the JSON file and detect an attempt by the user to add a component to the application being edited in the project. In response to detecting this user interaction or activity, the development tool may request the RA service interface 605 to provide a code snippet relating to the creation and definition of a new component. The RA service may identify a corresponding component code snippet (e.g., embodied as a JSON code snippet) and provide the snippet (at 940) to the development tool, which the development tool may cause to be immediately presented within a corresponding portion of the code editor window. The user may adopt the code snippet and begin editing various aspects and values of the snippet. For instance, a folder element within the snippet may be edited and the development tool 250 may identify this attempt to edit the folder element. In response, the development tool 250 may send yet another request 945, for instance, to obtain guidance from the RA service. In this example, the RA service interface 605 may provide a folder list (e.g., based on an underlying deployment model) to the development tool (through response 950) and the folder list may be presented in the GUI of the development tool 250 for potential adoption by the user. Further request-response transactions may take place responsive to various events detected at the development tool corresponding to various user actions. It should be appreciated that the example of FIG. 9 is provided as a simplified illustration, and that different and more granular events, requests, responses, and presentations may be performed in connection with the RA service's pairing with a development tool. In some cases, the native functionality of the development tool may drive how the information obtained from the RA service is used. Additional actions may also be performed, such as the deployment of code edited in development tool using the release automation system. Indeed, calls to use release automation functionality may also be called using an RA service interface. In the example of FIG. 9, a user may request that a modified version of an application or application component may be added to a backend system. For instance, a user request to save changes or import the file may cause a request 955 for the release automation system to import the file to a particular backend system to make the updated file available for a future automated deployment by the release automation system (which may also be requested directly from an example development tool through its interface with the release automation system), among other example requests.

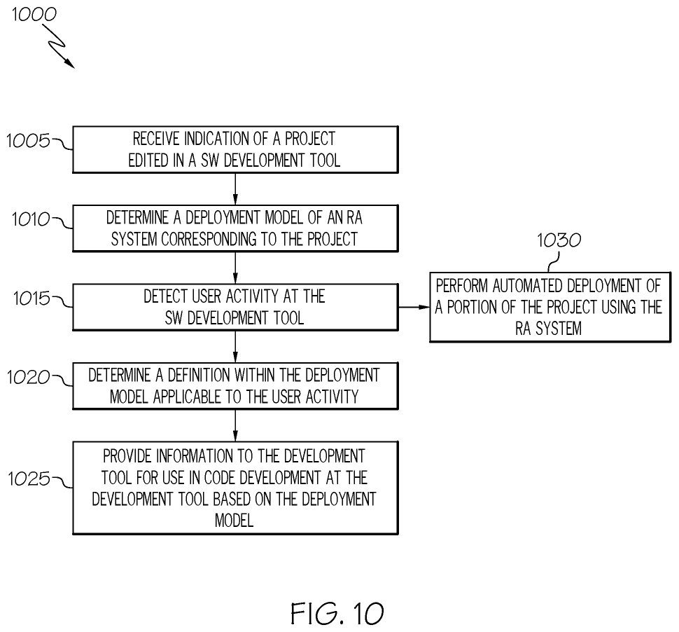

FIG. 10 is a simplified flowchart 1000 illustrating an example technique for providing a release automation engine as a service to an example development tool. For instance, an indication of a project being edited, developed, or otherwise worked on in the development tool may be received 1005 at a release automation system (i.e., from the development tool through a service interface). The release automation system may determine that one or more particular deployment models and/or specific model definitions within the particular deployment model are relevant to the identified project. User activities at the development tool may be detected 1015 (i.e., as reported by the development tool to the release automation system), which relate to development of the project. In some cases, these user actions may indicate a request to invoke or access one or more functions or resources of the release automation system, such as launching an automated deployment 1030 of a portion of an application (e.g., a portion developed or edited using the development tool) based on an input received in a GUI of the development tool. In other instances, an assumed or predicted intention of the user activity may be determined and a definition within the deployment model may be determined to contain information relevant to the user activity and user's assumed intention. This information may be provided 1025 to the development tool to cause language services or other assistance to be provided and presented at the development tool. For instance, code completion suggestions, validation warnings, value options, errors, or other assistance may be presented in a GUI of the development tool in accordance with the information provided from the release automation system based on the definition with in the deployment model, among other example implementations and features.

The flowcharts and block diagrams in the Figures illustrate the architecture, functionality, and operation of possible implementations of systems, methods and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

1. A method comprising:
receiving data indicating a project opened in an integrated development environment (IDE) hosted on a computing device;
identifying a deployment model of a release automation system associated with the project, wherein the release automation system is remote from the computing device, the deployment model comprises a definition of a workflow to be executed to perform automated deployment of applications, and the deployment model further comprises a definition of an environment comprising one or more target computing systems;
receiving data indicating a user interaction with the IDE;
determining that a particular definition within the deployment model is relevant to the user interaction and the project; and
causing, through an interface between the IDE and the release automation system, information from the particular definition to be presented in a graphical user interface of the IDE based on the user interaction.

2. The method of claim 1, further comprising:
receiving, through the graphical user interface, a user request to deploy particular code in the project within the environment; and
performing an automated deployment of the particular code on a particular one of the one or more target systems in response to the user request and based on the deployment model.

3. The method of claim 2, wherein the definition of the workflow defines steps and logic used to perform the automated deployment, the automated deployment is performed in accordance with the steps and using the logic defined in the definition of the workflow, and the particular target system is defined in the definition of the environment.

4. The method of claim 1, wherein the deployment model comprises a definition of an application to be deployed and defines components of the application.

5. The method of claim 4, wherein the information comprises presentation of code for adoption in the project based on one or more components of the application as defined in the deployment mode.

6. The method of claim 5, wherein the presentation of code comprises a code template based on code in one or more of the components of the application.

7. The method of claim 6, wherein the code template comprises a field and the field enables selection of one of a set of selectable values based on the deployment model for adoption within the code.

8. The method of claim 1, wherein the user interaction comprises entry of code within a code editor of the IDE.

9. The method of claim 8, wherein determining that the particular definition within the deployment model is relevant to the user interaction comprises parsing code entered in the code editor within a context defined in the deployment model.

10. The method of claim 8, wherein the presented information comprises dynamic highlighting of a portion of the code to indicate validity of the code based on the deployment model.

11. The method of claim 8, wherein the presented information comprises presentation of suggested code to enter in the code editor based on the deployment model.

12. The method of claim 1, wherein the presented information comprises presentation of a menu of code snippets or folders for use in the project based on the deployment model.

13. The method of claim 1, wherein the IDE comprises a particular type of IDE, and the method further comprises receiving data from and providing information based on the deployment model for presentation in a graphical user interface of another, different type of IDE.

14. A non-transitory computer readable medium having program instructions stored therein, wherein the program instructions are executable by a computer system to perform operations comprising:
interfacing a release automation system with an integrated development environment (IDE) tool hosted on another computing system to expose functionality of the release automation system to the IDE tool, wherein the release automation system comprises a deployment model, the deployment model comprises a definition of a workflow to be executed to perform automated deployment of applications, and the deployment model further comprises a definition of an environment comprising one or more target computing systems;
causing information to be presented in a graphical user interface of the IDE tool based on the deployment mode;
receiving, from the IDE tool, a user request provided at the IDE tool to perform an automated deployment of particular code opened for editing within the IDE tool; and
performing an automated deployment of the particular code on a particular one of the one or more target systems in response to the user request and based on the deployment model.

15. The computer readable medium of claim 14, wherein the definition of the workflow defines steps and executable logic used to perform the automated deployment, the automated deployment is performed in accordance with the steps and using the logic defined in the definition of the workflow, and the particular target system is defined in the definition of the environment.

16. A system comprising:
one or more data processing apparatus;
a memory;
a release automation system comprising an interface to communicate with one or more integrated development environment (IDE) tools hosted on remote host systems, wherein the release automation system is executable to:
receive data over the interface indicating a project opened in a particular one of the one or more IDE tools;
identify, in the memory, a deployment model of the release automation system associated with the project, wherein the deployment model comprises a definition of a workflow to be executed to perform automated deployment of applications, and the deployment model further comprises a definition of an environment comprising one or more target computing systems;
receive data over the interface indicating a user interaction with the IDE;
determine that a particular definition within the deployment model is relevant to the user interaction and the project; and
cause, through an interface between the IDE and the release automation system, information from the particular definition to be presented in a graphical user interface of the IDE based on the user interaction

17. The system of claim 16, wherein the interface comprises a Representational State Transfer (REST) application programming interface (API).

18. The system of claim 16, wherein the release automation system is further executable to perform an automated deployment of at least a portion of an application on the one or more target computing systems using the deployment model.

19. The system of claim 18, wherein performing the automated deployment comprises:
identifying a particular component of the application based on the deployment model;
identifying an agent in an operating system of a particular one of the target computing systems based on the deployment model; and
causing the agent to perform deployment steps defined in the definition of the workflow to deploy the particular component on the particular target computing system and apply particular configuration parameters to the deployment of the particular component.

20. The system of claim 18, wherein the automated deployment is triggered through an input received through the graphical user interface of the IDE tool.
